(19) United States
(12) Patent Application Publication
(10) Pub. No.: US 2024/0101824 A1
(43) Pub. Date: Mar. 28, 2024

(54) BARRIER COATINGS, FREE-STANDING STRUCTURES, ASSOCIATED PRODUCTS AND ASSOCIATED METHODS

(71) Applicant: GREEN SOL-GEL LIMITED, Sittingbourne, Kent (GB)

(72) Inventor: Fanya Ismail, Sittingbourne, Kent (GB)

(73) Assignee: Green Sol-Gel Ltd., Sittingbourne, Kent (GB)

(21) Appl. No.: 18/273,459

(22) PCT Filed: Jan. 25, 2022
(86) PCT No.: PCT/GB2022/050193

§ 371 Date: Jul. 20, 2023

(30) Foreign Application Priority Data
Jan. 25, 2021 (GB) 2101002.0
May 7, 2021 (GB) 2106563.6

(51) Int. Cl. C08L 89/00; C08J 5/00; C08J 5/18; C08K 3/22; C08K 3/36; C09D 189/06; C09J 189/00; D21H 17/22; D21H 19/50

(52) U.S. Cl. CPC C08L 89/00; C08J 5/005; C08J 5/18; C08K 3/22; C08K 3/36; C09D 189/06; C09J 189/00; D21H 17/22; D21H 19/50; C08K 2003/2231

(57) ABSTRACT

A sol comprising a solvent, an alkoxide, a catalyst, and a protein, wherein the protein is a plant-derived protein, an animal-derived protein, a fungus-derived protein, or any combination thereof. The sol may be used to immobilise pigment. The sol may be used to form a fluid resistant or impermeable barrier and/or a free-standing unsupported structure.

### INTRODUCTION

The present invention relates to colloidal solutions (known as sols), the use of sols to form coatings, barriers, free-standing objects, and methods of using such sols.

Commercial products in many applications benefit from water, oil, and/or gas resistance and/or impermeability. For example, paper, cardboard and other materials that are commonly used as packaging for commercial products will often include such a wall, barrier, or container portion for applications in which liquids or gasses must be retained within, or kept outside of, the product in question. The passage of water, oil, gas, and other fluids has traditionally been controlled by using functionalised coatings utilising impermeable plastic materials or composites. In many industries such as the food and beverage industry, plastics may be applied to otherwise permeable media to facilitate the retention of liquid products within a particular packaging item. Similar methods may also be used to prevent the ingress of fluid into an item that may become compromised by exposure to water, air or other fluids. In an example, some paper or cardboard products are subjected to a process called internal sizing or surface sizing wherein hydrocarbon-derived materials such as microplastics are used to modify the porosity, adsorption, wear resistance, or other properties of the material. The materials used to produce existing functionalised coatings are generally produced from feedstocks with an associated environmental cost. For example, plastic materials are generally sourced from hydrocarbon feedstocks whereas metallic coatings may originate from mining activities. The materials or chemicals used to manufacture such functional coatings and the associated by-products may also be toxic. Some materials may also degrade over time to produce particulates such as microplastics. Additionally, many such materials may release potentially harmful species through use. For example, per- and polyfluoroalkyl substances which have been linked to public health risks have been used to form water-resistant materials since the 1940s. Consequently, there are ongoing health and environmental concerns in relation to many common materials found in both consumer products and the industrial environment that are used to impart water, oil, and/or gas resistance and/or impermeability to commercial products.

The inventor of the present invention has found a novel, innovative and non-toxic alternative to conventional fluid resistant and/or impermeable coating and barrier compositions in the form of a sol. In this context, the term ‘sol’ refers to a dispersion of colloidal particles in a liquid solvent and may be referred to as a sol gel. A sol may also be referred to as a sol mixture. Many sols formed from small colloidal particles are substantially clear and colourless. For example, sols formed from silicon-based functional materials will generally be clear and colourless as the particles forming the sol are sufficiently small that they do not scatter light. Some sols formed from larger particles may be coloured and/or at least partially opaque. For example, sols formed from titanium-based functional materials may be visibly white. Sols may comprise readily available natural materials that ensure the resulting sols are inexpensive. Additionally, sols may be directly applied to a surface, i.e. without the surface needing to undergo a special preparation process, ensuring that sols are easy to use. Furthermore, some sols have been shown to provide a durable and thermally resistant coating, demonstrating that sols may form resilient and long-lasting functional coatings. The inventor of the present invention has further appreciated that the use of one, two, or more sol barriers or coatings wherein at least one of the sols includes a protein may enhance one or more properties of the coating, barrier and/or product with which the sols are used. The inventor of the present invention has further appreciated that such sols may be used to immobilise pigment. The inventor of the present invention has further appreciated that such sols as used in sol barriers may form free-standing shapes, objects, or the like, which retain the functional characteristics of the sol barriers or coatings free of a supporting surface.

According to one aspect of the invention, there is provided a sol comprising a solvent, an alkoxide, a catalyst, and a protein, wherein the protein is a plant-derived protein, an animal-derived protein, a fungus-derived protein, or any combination thereof. The alkoxide may be selected from silicon alkoxides, metal alkoxides, phosphorus alkoxides, organically modified alkoxides, and any combination thereof. The alkoxide may be selected from n-propyltriethoxysilane, tetrapropyl orthosilicate, titanium(IV) tert-butoxide, titanium(IV) isopropoxide, triethyloxysilane, methyltriethyloxysilane, triethoxy(octyl)silane, phenyl-triethoxysi lane, titanium(IV) ethoxide, triethoxy-silylcyclopentane, (3-glycidyloxypropyl) trimethoxysilane, cyclopentyltriethoxysilane, 3-amino-propyltriethoxysilane, triethoxy-3-(2-imidazolin-1-yl)propylsilane, and any combination thereof. The catalyst may be at least one of an acid and/or a base. The catalyst may be selected from hydrochloric acid, citric acid, nitric acid, acetic acid, sodium hydroxide, potassium hydroxide, ammonia, and any combination thereof. The solvent may comprise water, one or more alcohols, and/or any combination thereof. The solvent may comprise methanol, ethanol, isopropanol, butanol, ethylene glycol or any combination thereof. The protein may comprise a plant-derived protein, optionally wherein the plant-derived protein comprises a prolamine protein. The protein may comprise vegetable protein, nut protein, seed protein, legume protein, bean protein, pulse protein, grass protein, or any combination thereof. The protein may comprise corn protein, pea protein, soy protein, oat protein, chickpea protein, wheat protein, barley protein, rye protein, sorghum protein, or any combination thereof. The protein may comprise corn protein, optionally wherein the corn protein is zein protein. The protein may comprise an animal-derived protein, optionally wherein the protein is a dairy protein, egg protein, poultry protein, livestock protein, or any combination thereof. The protein may comprise whey protein. The protein may comprise a fungus-derived protein, optionally wherein the protein is a chytridiomycota protein, a zygomycota protein, a glomeromycota protein, an ascomycota protein, a basidiomycota protein, or any combination thereof. The sol may consist essentially of a solvent, an alkoxide, a catalyst, and a protein. The sol may consist of a solvent, an alkoxide, a catalyst, and a protein.

According to another aspect of the invention, there is provided a process for forming a water, oil, and/or gas resistant and/or impermeable product, the process comprising: applying a first layer of a first sol to a water, oil and/or gas permeable product, the first sol comprising a sol in accordance with the first aspect of this invention; forming a water, oil, and/or gas resistant and/or impermeable barrier on at least part of the product. The process may further comprise applying a second layer of a second sol to the product, wherein the second sol comprises a solvent, an alkoxide, and a catalyst. The first sol and the second sol may be different. Only one of the first sol and second sol may comprise a protein. Alternatively, both the first sol and the second sol may comprise a protein. The process may comprise applying a second layer of a second sol to the product, wherein: the first sol is applied to the product prior to the application of the second sol to the product; or the second sol is applied to the product prior to the application of the first sol to the product. The first sol and/or second sol may be applied to the product by spraying the sol onto the product, soaking the product in the sol, dipping the product in the sol, roller coating the sol onto the product, brushing the sol onto the product, wiping the sol onto the product, drawing down the product, impregnating the product with the sol by padding, exhausting the sol on the product, flowing the sol onto the product, the use of slit coating techniques, the use of blade application techniques, or any combination thereof. Applying the first layer of the first sol to the product may comprise: partially drying at least a portion of the first sol to form an intermediate first sol layer; and contacting the intermediate first sol layer and the product; optionally wherein the process further comprises heating the sol layer and the product after contacting, pressing the product and the sol layer together after contacting, or any combination thereof. The intermediate first sol layer may be resiliently deformable, elastically deformable, or otherwise deformable.

According to a further aspect of the invention, there is provided a product comprising a coating formed from a sol as substantially described herein.

According to yet another aspect of the invention, there is provided a free-standing object derived from a sol, the sol comprising a solvent, an alkoxide, a catalyst, and a protein, wherein the protein is a plant-derived protein, an animal-derived protein, a fungus-derived protein, or any combination thereof. The free-standing object may be substantially solid. The alkoxide may be selected from silicon alkoxides, metal alkoxides, phosphorus alkoxides, organically modified alkoxides, and any combination thereof. optionally wherein the alkoxide is selected from n-propyltriethoxysilane, tetrapropyl orthosilicate, titanium(IV) tert-butoxide, titanium(IV) isopropoxide, triethyloxysilane, methyltriethyloxysilane, triethoxy(octyl)silane, phenyl-triethoxysilane, titanium(IV) ethoxide, triethoxy-silylcyclopentane, (3-glycidyloxypropyl) trimethoxysilane, cyclopentyltriethoxysilane, 3-amino-propyltriethoxysilane, triethoxy-3-(2-imidazolin-1-yl)propylsilane, and any combination thereof. The catalyst may be at least one of an acid and/or a base, optionally wherein the catalyst may be selected from hydrochloric acid, citric acid, nitric acid, acetic acid, sodium hydroxide, potassium hydroxide, ammonia, and any combination thereof. The solvent may include water, one or more alcohols, and/or any combination thereof, optionally wherein the solvent may include methanol, ethanol, isopropanol, butanol, ethylene glycol or any combination thereof. The protein may include a plant-derived protein, optionally wherein the plant-derived protein includes a prolamine protein. The protein may include vegetable protein, nut protein, seed protein, legume protein, bean protein, pulse protein, grass protein, or any combination thereof, optionally wherein the protein includes corn protein, pea protein, soy protein, oat protein, chickpea protein, wheat protein, barley protein, rye protein, sorghum protein, or any combination thereof. The protein may include corn protein, optionally wherein the corn protein is zein protein. The protein may include an animal-derived protein, optionally wherein the protein includes a dairy protein, egg protein, poultry protein, livestock protein, or any combination thereof, optionally wherein the protein includes whey protein. The protein may include a fungus-derived protein, optionally wherein the protein includes a chytridiomycota protein, a zygomycota protein, a glomeromycota protein, an ascomycota protein, a basidiomycota protein, or any combination thereof. The free-standing object, the sol, or any combination thereof may include one or more functional additives. The one or more functional additives may include fibres. The one of more functional additives may be dispersed throughout the free-standing object.

According to a yet further aspect of the invention, there is provided a method of forming a free-standing object. The method includes: providing a sol comprising a solvent, an alkoxide, a catalyst, and a protein, wherein the protein is a plant-derived protein, an animal-derived protein, a fungus-derived protein, or any combination thereof; placing the sol into a mould; forming a shaped sol structure in the mould; removing the shaped sol structure from the mould to form a free-standing object. The method may include adding one or more functional additives to the sol prior to introduction to the mould, after the placing the sol into the mould, or during the forming the shaped sol structure in the mould. The method may include heating the sol, drying the sol, applying pressure to the sol, or any combination thereof.

According to an additional aspect of the invention, there is provided a product comprising a free-standing object as described herein. The product may consist essentially of the free-standing object. Alternatively, the product may include one or more additional intermediate products or components, work in progress products or components, and/or semi-finished products or components.

According to a yet once further aspect of the invention, there is provided a coating including a pigment and a sol, the sol including a solvent, an alkoxide, a catalyst, and a protein, wherein the protein is a plant-derived protein, an animal-derived protein, a fungus-derived protein, or any combination thereof. The sol may be any sol as described herein. The sol may form a sol layer and the pigment may be dispersed throughout the sol layer. The sol may form a layer and the sol layer may be in contact with the pigment. The coating may coat a product formed at least in part from one or more plant, animal, or fungus derived materials. The coating may coat a product formed at least in part from fungus derived materials. The pigment may be immobilised, or substantially immobilised by the sol. These aspects and others will be apparent to the skilled practitioner in the art with the benefit of this disclosure.

### BRIEF DESCRIPTION OF THE DRAWINGS

The present invention will be described with reference to the following drawings, in which:

FIGS. 1A to 1G show cross-sectional representations of products coated with one or more sols;

FIGS. 2A to 2D show the formation and application of a moulded sol layer to a shaped product;

FIGS. 3A to 3D show the formation and air-shaping of a sol layer to match the contours of a shaped product; and

FIG. 4 shows a high level process by which a fluid resistant or fluid impermeable product may be formed using a sol.

FIGS. 5A to 5D show the formation of a free-standing sol structure and its subsequent application to a product.

FIG. 6 shows a high level process by which a free-standing sol structure may be formed and optionally used.

### DETAILED DESCRIPTION

A sol may be formed by dispersing one or more materials of suitably small particle size in a solution. Some sols may further comprise additional components such as a catalyst or one or more functional components. The sols of the present invention that may impart water, oil, and/or gas resistance and/or impermeability generally comprise an alkoxide, a solvent, a catalyst, and a protein.

The alkoxide may be selected from silicon alkoxides, metal alkoxides, phosphorus alkoxides, organically modified alkoxides, and any combination thereof. The term ‘metal alkoxide’ includes alkoxides comprising metals, organically modified alkoxides comprising metals, alkoxides comprising metalloids, and organically modified alkoxides comprising metalloids. Where the sol comprises a metal alkoxide, the alkoxide will generally conform to the general formula M(OR)ₓ or R_{C}-M(OR)ₓ, where “M” denotes any metal forming the metal alkoxide which may hydrolyse in the presence of a suitable solvent. “R” and “R_{C}” denote alkyl radicals of typically 1 to 30 carbon atoms which may take any suitable form such as straight chain, branched, aromatic or complex. “x” will generally equate to the valence of the corresponding metal ion “M”. In an example, R may be a methyl, ethyl, propyl or butyl radical. Where a metal ion “M” has a valency in excess of 1, each R group may be the same. R_{C} denotes any suitable organic group which will form and maintain a covalent bond with the metal “M” following hydrolysis of the alkoxide. In some examples, R and R_{C} may be the same. In other examples, R and R_{C} may be different. Any suitable metal alkoxide may be used. Examples of suitable metal alkoxides include Si(OR)₄, Ti(OR)₄, Al(OR)₃, Zr(OR)₃ and Sn(OR)₄ as well as R_{C}—Si(OR)₃, R_{C}—Ti(OR)₃, R_{C}—Al(OR)₂, R_{C}—Zr(OR)₂ and R_{C}—Sn(OR)₃. In specific examples, R may be the methyl, ethyl, propyl or butyl radical. In some specific examples, R_{C} may be a phenyl group, a cyclopentyl group, or any other suitable organic group capable of maintaining a covalent bond to the metal. The metal of the metal alkoxide may comprise silicon, titanium, aluminium, zirconium, tin, or any other suitable metal. In particular examples, the metal alkoxides may be selected from the group comprising Ti(isopropoxy)₄, Al(isopropoxy)₃, Al(sec-butoxy)₃, Zr(n-butoxy)₄, Zr(n-propoxy)₄, n-propyltriethoxysilane, tetrapropyl orthosilicate, titanium(IV) tert-butoxide, titanium(IV) isopropoxide, triethyloxysilane, methyltriethyloxysilane, triethoxy(octyl)silane, phenyl-triethoxysilane, titanium(iv) ethoxide, triethoxy-silylcyclopentane, (3-glycidyloxypropyl) trimethoxysilane, cyclopentyltriethoxysilane, 3-amino-propyltriethoxysilane, triethoxy-3-(2-imidazolin-1-yl)propylsilane, and any combination thereof. In selected examples, the metal alkoxides may be selected from the group comprising tetraethoxysilane, phenyltriethoxysilane, methyltriethyloxysilane, and any combination thereof. In further selected examples, the metal alkoxides may be selected from the group comprising tetrapropyl orthosilicate, titanium(IV) tert-butoxide, titanium(IV) isopropoxide, triethyloxysilane, methyltriethyloxysilane, triethoxy(octyl)silane, phenyl-triethoxysi lane, titanium(iv) ethoxide, triethoxy-silylcyclopentane, (3-glycidyloxypropyl) trimethoxysilane, cyclopentyltriethoxysilane, or any combination thereof. In additional selected examples, the metal alkoxide may be selected from the group comprising Ti(isopropoxy)₄, Al(isopropoxy)₃, Al(sec-butoxy)₃, Zr(n-butoxy)₄, Zr(n-propoxy)₄, and n-propyltriethoxysilane-based alkoxides, and any combination thereof.

The solvent used in the formation of the sol may comprise water, one or more alcohols, any other suitable solvent, or any combination thereof. Where present, the one or more alcohols may comprise methanol, ethanol, butanol, ethylene glycol, isopropanol, any other suitable alcohol, and any combination thereof. Bio-solvents such as bio-ethanol may also be used.

Suitable catalysts for use in the sols described herein include at least one of an acid or a base. Examples of acid catalysts include hydrochloric acid, citric acid, nitric acid and acetic acid. Examples of basic catalysts include sodium hydroxide, potassium hydroxide and ammonia.

The protein included as part of the sol may include a plant-derived protein, an animal-derived protein, a fungus-derived protein, or any combination thereof. The derivation of a protein generally indicates the origin or source of such a protein which may, in turn, dictate the chemical properties, characteristics, and functionality of said protein. In an example, a ‘plant-derived protein’ refers to any protein or combination of proteins that may be obtained, extracted, produced, or otherwise acquired from the biological classification group of plants and their byproducts. Similarly, an ‘animal-derived protein’ refers to any protein or combination of proteins that may be obtained, extracted, produced, or otherwise acquired from the biological classification group of animals and their byproducts. A ‘fungus-derived protein’ refers to any protein or combination of proteins that may be obtained, extracted, produced, or otherwise acquired from the biological classification group of fungus. Where the protein includes a plant-derived protein, the plant-derived protein may include vegetable protein, nut protein, seed protein, legume protein, bean protein, pulse protein, grass protein, any other suitable plant protein, or any combination thereof. The protein may include corn protein, pea protein, soy protein, oat protein, chickpea protein, wheat protein, barley protein, rye protein, sorghum protein, or any combination thereof. The protein may be a prolamin protein or a protein with a high concentration of the amino acid proline. Where the protein includes a prolamin protein, the protein may include zein protein, gliadin protein, hordein protein, kafirin protein, avenin protein, secalin protein, any other suitable prolamin protein, or any combination thereof. In one example, the protein may include, consist of, or consist substantially of, zein protein. Where the protein includes an animal-derived protein, the protein may include a dairy protein, egg protein, poultry protein, livestock protein, any other suitable animal-derived protein, or any combination thereof. In one example, the protein may include, consist of, or consist substantially of, whey protein. Where the protein includes a fungus-derived protein, the protein may include a chytridiomycota protein, a zygomycota protein, a glomeromycota protein, an ascomycota protein, a basidiomycota protein, any other suitable fungus-derived protein such as protein derived from mushroom mycelium, or any combination thereof. Any suitable combination of protein disclosed herein may be used in the sols of the present invention. For example, the protein may include a pea protein; a hemp protein; a zein corn protein; a rice protein; an egg protein; a whey protein; a mushroom protein such as champignon mushroom, cordyceps mushroom, and maitake mushroom; or any combination thereof. For example, the protein may comprise a zein protein and a whey protein. In another example, the protein may comprise a basidiomycota protein and a legume protein. The specific protein, or combination of protein, to be used will depend upon the properties and characteristics desired to be imparted to the sol and the eventual product. Selection of protein may depend upon the chemical functionality of the protein, the manner in which it will interact with the other components of the sol, and/or any other suitable criteria. In some examples, the protein may be wholly or substantially free of other substances that may commonly be derived from the source of the protein such as plants, animals, fungus, or the like. More particularly, in such examples, the protein may contain no other components such as non-proteins. In these examples, the protein may not be a flour such as, for example, wheat flour due to the components of such flours which are not themselves proteins. In such an example, the protein may be wholly or substantially free of starch, polysaccharides, lipids, non-protein biopolymers, fats, and other non-protein substances commonly found in plant, animal, and fungus flours.

The proportions of each component used to form the sol may be any suitable range of proportions suffice that the resultant mixture forms a sol that may then be subsequently used in the techniques, applications, and/or methods described herein. The sol may include about 0.1% to about 80% of the alkoxide component by total weight of the sol. For example, the sol may include the alkoxide in a proportion of about 0.1% to about 75%, about 0.1% to about 70%, about 0.1% to about 65%, about 0.1% to about 60%, about 0.1% to about 55%, about 0.1% to about 50%, about 0.1% to about 45%, about 0.1% to about 40%, about 0.1% to about 35%, about 0.1% to about 30%, about 0.1% to about 25%, about 0.1% to about 20%, about 0.1% to about 15%, about 0.1% to about 10%, about 0.1% to about 5%, about 1% to about 80%, 1% to about 75%, about 1% to about 70%, about 1% to about 65%, about 1% to about 60%, about 1% to about 55%, about 1% to about 50%, about 1% to about 45%, about 1% to about 40%, about 1% to about 35%, about 1% to about 30%, about 1% to about 25%, about 1% to about 20%, about 1% to about 15%, about. 1% to about 10%, or about 1% to about 5% of the total weight of the sol. Similarly, the sol may include the alkoxide in a proportion of about 5%, about 10%, about 15%, about 20%, about 25%, about 30%, about 35%, or about 40%, up to an upper range of about 45%, about 50%, about 55%, about 60%, about 65%, about 70%, about 75%, or about 80% by total weight of the sol.

The sol may include about 1% to about 98% of the solvent component by total weight of the sol. For example, the sol may include the solvent in a proportion of about 1% to about 95%, about 1% to 90%, about 1% to about 85%, about 1% to about 80%, about 1% to about 75%, about 1% to about 70%, about 1% to about 65%, about 1% to about 60%, about 1% to about 55%, about 1% to about 50%, about 1% to about 45%, about 1% to about 40%, about 1% to about 35%, about 1% to about 30%, about 1% to about 25%, about 1% to about 20%, about 1% to about 15%, about 1% to about 10%, about 1% to about 5%, about 5% to about 95%, about 5% to about 90%, about 5% to about 85%, about 5% to about 80%, about 5% to about 80%, 5% to about 75%, about 5% to about 70%, about 5% to about 65%, about 5% to about 60%, about 5% to about 55%, about 5% to about 50%, about 5% to about 45%, about 5% to about 40%, about 5% to about 35%, about 5% to about 30%, about 5% to about 25%, about 5% to about 20%, about 5% to about 15%, or about. 5% to about 10% of the total weight of the sol. Similarly, the sol may include the solvent in a proportion of about 10%, about 15%, about 20%, about 25%, about 30%, about 35%, about 40%, or about 45%, up to an upper range of about 50%, about 55%, about 60%, about 65%, about 70%, about 75%, about 80%, about 95%, or about 98% by total weight of the sol.

The sol may include about 0.01% to about 40% of the catalyst by the total weight of the sol. For example, the sol may include the catalyst in a proportion of about 0.01% to about 35%, about 0.01% to about 30%, about 0.01% to about 25%, about 0.01% to about 20%, about 0.01% to about 15%, about 0.01% to about 10%, about 0.01% to about 5%, about 0.01% to about 1%, about 0.1% to about 40%, about 0.1% to about 35%, about 0.1% to about 30%, about 0.1% to about 25%, about 0.1% to about 20%, about 0.1% to about 15%, about 0.1% to about 10%, about 0.1% to about 5%, about 0.1% to about 1%, about 1% to about 40%, about 1% to about 35%, about 1% to about 30%, about 1% to about 25%, about 1% to about 20%, about 1% to about 15%, about 1% to about 5%, about 5% to about 40%, about 5% to about 35%, about 5% to about 30%, about 5% to about 25%, about 5% to about 20%, about 5% to about 15%, about 5% to about 10%, or about 10% to about 15% by the total weight of the sol. Similarly, the sol may include the catalyst in a proportion of about 10%, about 15%, or about 20%, up to an upper range of about 25%, about 30%, about 35%, or about 40% by total weight of the sol.

The sol may include about 0.1% to about 60% of the protein component by total weight of the sol. For example, the sol may include the protein in a proportion of about 0.1% to about 55%, about 0.1% to about 50%, about 0.1% to about 45%, about 0.1% to about 40%, about 0.1% to about 35%, about 0.1% to about 30%, about 0.1% to about 25%, about 0.1% to about 20%, about 0.1% to about 15%, about 0.1% to about 10%, about 0.1% to about 5%, about 1% to about 60%, 1% to about 55%, about 1% to about 50%, about 1% to about 45%, about 1% to about 40%, about 1% to about 35%, about 1% to about 30%, about 1% to about 25%, about 1% to about 20%, about 1% to about 15%, about 1% to about 10%, or about 1% to about 5% of the total weight of the sol. Similarly, the sol may include the protein in a proportion of about 5%, about 10%, about 15%, about 20%, about 25%, or about 30%, up to an upper range of about 35%, about 40%, about 45% about 50%, about 55%, or about 60% by total weight of the sol.

The proportion by weight of each component of the sol may depend upon the maximum solubility of one or more components and/or the suspension characteristics of one or more components in another of the one or more components of the sol.

The sol may be formed by dispersing an alkoxide of suitably small particle size in a solvent and adding a catalyst and a protein. The alkoxide may be a particle with at least one dimension in the range of approximately 1 nm to 1 μm. An alternative method of making a sol involves adding the solvent and catalyst to the protein prior to the addition of the alkoxide. The protein will generally be in the form of a liquid when forming the sol or prior to its introduction to the other components of the sol. The protein may therefore be dissolved or dispersed in a solvent prior to its addition to the sol. The mixing of the liquid sol components and the liquid protein ensures that the sol components such as the alkoxide and the protein are well mixed and evenly dispersed and distributed throughout the sol. In some examples, the protein added when forming the sol is entirely, or substantially entirely, in the liquid phase and as such may have no or minimal solid phase component. In some methods of preparation, a sol may be formed from a solvent, an alkoxide and a catalyst and then stored for a period of time prior to addition of the protein.

The sol may optionally include one or more functional additives. A functional additive includes any species other than the solvent, alkoxide, catalyst and protein that may be used to adjust the properties of the sol. For example, a functional additive may be used to control viscosity, density or rheology of the sols; to make the sol suitable for UV, visible or IR curing; and/or may be used to add additional functionality to a coating prepared using the sol, e.g. colour, pH sensitivity, conductivity, fluorescence. The functional additives used will vary depending on the intended use of the sol. Suitable functional additives include photoinitiators, resins, oils, dyes (including pH sensitive dyes and fluorescent dyes), salts, surfactants, composite particles, pigment(s), mineral or other inorganic particles (including carbonates, carbides, oxides, hydroxides, nitrates, bromides, and the like), and metal particles (including alloys and particles comprising one or more metals and one or more additional non-metal components). Where additives are in the form of a particle, the particle may be any suitable shape such as spherical, substantially spherical hemi-spherical, substantially hemi-spherical, cubic, substantially cubic, fibrous, substantially fibrous, cylindrical, substantially cylindrical, planar, substantially planar, elongate, substantially elongate, or any other suitable shape. Functional additives may include, but are not limited to, lignin, nano-cellulose, micro-cellulose, calcium carbonate, clay, kaolin, gelatine, oleic acid, rosemary oil, black seed oil, wood chips, natural fibres, waste fibres, sand, cellulose, starch, sorbitol, plasticising agents, and the like, or any combination thereof. One or more functional additives may be added at any stage in the formation of the sol. For example, one or more functional additives may be added alongside the alkoxide component. In another example, one or more functional additives may be added after contacting the solvent and the alkoxide. A functional additive may similarly be added before or after the protein has been added to the sol solution. The sols may also be formed without the presence of any functional additives. As such, the sol may be wholly or substantially free of functional additives.

The sols used in the present invention may be used without being modified before use. Thus, the coatings, products, and coated products prepared using sols in accordance with the present invention may be prepared from products and a sol without the sol being modified before use. For example, a fluid resistant or fluid impermeable product may be prepared from a product and a sol directly without processing the sol or including further additives or components to the sol. Alternatively, the sols used in the present invention may be modified before use. For example, the sols used in the present invention may be modified by diluting a sol with a solvent, combining a sol with functional additives, or both diluting a sol with a solvent and combining a sol with one or more functional additives. Suitable solvents for use in diluting the sol include the solvent used to disperse the alkoxide when forming a sol (sometimes referred to as the sol solvent), other solvents that are miscible with the sol solvent, or combinations thereof.

Sols are generally stable by definition. A sol may therefore be formed some time prior to use of the sol. For example, the sol may be formed and stored for a period of up to 1 hour, up to 1 day, up to 1 week, up to 1 year, up to 10 years, or more prior to use of the sol. However, the sol may also be formed immediately prior, less than 2 seconds prior, less than 15 seconds prior, less than 30 seconds prior, less than a minute prior, or less than an hour prior to use of the sol. Use of the sol in such examples may include coating one or more products with the sol.

The sol may be formed in geographical proximity to the location at which it will be used. Alternatively, the sol may be formed distant from the site at which the sol is to be used and then transported to that site. In an example, the sol may be formed at a manufacturing site in an on-line process a matter of seconds before it is applied to one or more products. In another example, the sol may be formed in an independent manufacturing facility and then transported by road, rail, air, sea, pipeline or equivalent to a geographically distinct site where the sol is applied to one or more products. More generally, sols may be formed distinct from the product to which the sol is to ultimately be applied, where appropriate. In such an example, the sol and the product to which the sol is to be applied will be brought together following formation of the sol. Alternatively, a sol may be formed around a product to which the sol is to be applied such that the formed sol coats the product immediately, substantially immediately, or shortly after formation.

The term ‘product’ as used herein is intended to include intermediate, work in progress and unfinished products and their components in addition to otherwise finished goods and articles. For example, applying the sol to a product may involve applying the sol to a product component that has not yet been finished in its final commercial form. Similarly, the sol may be applied to a finished product that is otherwise complete. Applying the mixture to a product may involve coating all or a portion of the outer surface of a product with the sol dispersion or suspension. In general, the mixture may be applied to the product by any suitable method, including brushing, spraying, spray drying, rolling, dropping, transferring, submersion, immersion, mixing, spreading, blading, padding, and the like. Individual or multiple methods of application may be utilised to apply the sol to a single product or article depending on the nature of the product and the properties and characteristics desired. It may be advantageous to form a sol coating on a product via brushing, spraying, padding, immersion, blading or rolling such that the sol is spread in a layer over the area of the product to be coated.

The sols may be used in the manufacture of products used in a range of industries such as the automotive, engineering, construction, aviation, marine, defence, electronics (including photo-electronics and sensors), energy (including batteries, energy storage and renewable energy), photonics, food, medical, household products, paper, adhesives, interior or exterior decoration, home improvement, additive manufacturing, oil and gas, separation and purification, fashion, and cosmetics industries. The sols may be used in the preparation of products comprising materials such as wood, textiles, leather, metal (including alloy), concrete, cardboard, paper, plastic, bioplastic, glass, ceramics, sand, brick, electronic circuitry, marble, soil, painted surfaces and combinations thereof, wherein combinations thereof includes composite products and biocomposite products. The product may be a fibre product such as a textile product, paper product, cardboard product, or similar product formed from one or more fibrous materials. The product may be a wood product such as a board, beam, shaped timber, wood product, wooden object, or the like. The product may be a leather product such as a full grain leather, a top grain leather, a genuine leather product, a split grain leather product, a bonded leather product, or any other suitable leather product. In general, any suitable product substrate may be coated with the sols described herein.

The sols of the present invention may be applied to products that are uncoated, coated with non-sol coatings, or products that have already been coated previously with the same sol or with another sol, e.g. to impart a thicker functional layer of the same sol or to impart a range of functional benefits when the sol used to form the first coating and the sol used to form the second coating are different. In this manner, the sol may be used to form a primer coating on a product prior to the application of a further one or more coating layers which may or may not also include sols. For example, a sol primer may be used on a paper or cardboard product. In another example, a sol may be used as a sizing agent in the formation of a paper or cardboard product. In yet another example, a sol may be applied to a paper already coated with a coating layer such as a fluid resistant or fluid impermeable coating layer which does not comprises a sol. Any desired number of different layers of sol coatings may be formed. In an example, two sol layers may be formed. In another example, 3 sol layers may be formed. In other examples, 4, 5, 6, 7, 8, 9, or more sol layers may be formed. Furthermore, any number or other, or further, coating layers which do not include sols may be included around, between, beneath, or on top of each layer of sol. Where multiple layers of sol coatings are used then all coating layers may comprise one or more sols with at least one sol comprising a protein as per the present invention. Multiple sol layers may include one or more proteins. Where multiple sol layers include one or more proteins, such layers may be spaced by one or more layers of sols which do not include a protein. Alternatively, one or more layers spaced between or around the different layers of sol coating may be free of sols or substantially free of sols. The products to be coated by sols of the present invention may be formed from any suitable material. More particularly, the product may comprise wooden products, textile products, leather products, metal (including alloy) products, concrete products or construction materials, cardboard products, paper or pulp products, plastic products, glass products, ceramic products, composite materials, electronic circuitry, sands, bricks, marbles, soils, paints, painted products, food and beverage products, utensils such as cutlery, medical devices, pharmaceutical products and combinations thereof. In some examples, a paper product may include a paper sheet, a paper napkin, a paper tissue, a greeting card, a business card, or any other suitable product. The product may be in the form of one or more particles, fibres, moulded products (including regular and irregular shaped moulded products), sheets, molecules (such as sol-gel encapsulated small molecules for drug delivery) and combinations thereof. Products coated with the sol may be permeable or porous prior to coating with the sol. Alternatively, products coated with the sol may be fluid resistant, fluid impermeable or non-porous prior to coating with the sol. An example of a non-porous and impermeable product may be a metal or glass sheet. The coated products may form part of a secondary product or be used in the manufacture of a secondary product such that the secondary products benefit from the functionality of the sol. For example, the coated products may comprise particles or fibres that are used in the manufacture of a composite product. Specific examples of coated products or secondary products comprising coated products include packaging (such as food and drink packaging, medical packaging, cosmetics packaging, batteries packaging and electronic device packaging), medical devices, fluid receptacles, culinary utensils and accessories, fibre-based products, or any product that may benefit from a fluid resistant or fluid impermeable barrier or coating. The sols described herein may therefore be used for form a composite product or a portion of a composite product. A sol coating may cover the entire surface of a product. Alternatively, a sol layer may cover only a portion of a product. In an example, a sol may be used to coat only the portion of a product that will be exposed to undesirable fluids during manufacture or use. In another example, a sol may be used to cover pinhole pores running through a paper sheet. In a particular example, a sol layer may be applied to the entirety of a product and a second layer may be applied only to regions of the coated product where pinhole pores may be formed. A product coated with multiple layers of sol may therefore have each sol layer applied to a different proportion of the surface of a product and/or different sols applied to different regions of the coated product.

The sols of the present invention have surprisingly been found to be particularly effective at the retention of pigment(s) on the surface of a product. Some coloured, printed, or otherwise pigmented products or product surfaces may experience wear, erosion, bleeding, discolouration, bleaching, loss of pigment, or other physical processes that result in the loss or reduction in colour from a surface or product. Applying the sols of the present invention to a pigmented product has been found to reduce or completely prevent the loss of pigment from the product or surface. The sols may be applied to a product to form one or more coating layers, sol layers, or the like. Sols comprising proteins have been found to be particularly effective at the retention of pigment on a product surface. In another example, sols as substantially described herein have been shown to be effective at retaining pigment present in or on products formed at least in part from biomaterials such as mushroom- or fungus-derived materials. The pigment to be retained may be added to the sol as a functional colouring additive. In examples where the pigment is included in the sol prior to, or during application to a product, the pigment may be dispersed throughout the sol. In other examples, the sol may be substantially free of pigment at the point at which it is applied to the product. The pigment, where present, may be present within or on the exposed surface of the product to which the sol is applied. The sol may then form a layer in contact with the pigmented surface, or may permeate the pigmented surface to form a sol layer that at least partly contains, encompasses, or encapsulates the pigmented surface. In this manner, the sol layer may contact the pigment to be immobilised by the sol. Without being bound by theory, it is believed that the sol forms a barrier that prevents damage, weathering, erosion, or other wear of the pigment. Moreover, in examples where the pigment is included in the sol and/or the sol permeates a pigmented surface, the network structure formed by the sol may immobilise the pigment by forming around the pigment compound such that the pigment compound becomes ‘trapped’ within the sol network. As described herein, sols may form water, gas, and/or oil resistant and/or impermeable barriers and the formation of such barriers to protect pigmented surfaces may further prevent loss or undesired migration of pigment. The use of a sol including one or more pigments in combination with a product that is also dyed and/or pigmented has also been shown to provide more than an additive effect since it results in an enhanced colouration when compared to the use of a pigmented product or pigmented sol alone.

The sols of the present invention have also surprisingly been found to improve the deformation resistance of some products. For example, products that are porous or that have a structure that allows the sol to migrate at least partially into the surface of the product may exhibit increased resistance to deformation following application of the sol. Without being bound by theory, it is believed that the network structure formed by the sol following drying strengthens a material by filling void spaces and by providing a secondary support network which may act to resist deformation forces acting upon the product. The deformation resistance may also extend to deformation derived from exposure of a product to a fluid. In one example, ingress of fluid such as water into the structure of a porous material may cause the product to swell and deform. The formation of a fluid resistant and/or impermeable barrier upon the surface of the product, and/or the filling of void spaces in the product that would otherwise become filled with fluid, may prevent such products from deforming under the influence of fluid exposure. In one particular example, a wooden child's toy may become soft, deform, and/or lose its shape if an uncoated or untreated toy is submerged in a bath. A toy coated with the sols described herein may resist or be wholly unaffected by submersion in water and therefore retain its size and shape. The deformation resistance is not limited solely to wooden objects and may be applicable to any porous or otherwise permeable product to which a sol may be applied. Some examples of such products, which may or may not be wooden, include furniture, beach toys and tools, construction materials, or any other suitable product.

Sol barriers formed from the sols of the present invention may also be formed in isolation from a product. For example, a free-standing sol structure may be formed on a surface or in a mould, removed from said surface or mould, and then transferred or applied to a product at a later time. After formation, the unsupported sol structure may be shaped via mechanical means or subjected to shaping via gas moulding to form a shape that may fit onto the contours of the surface of a desired product. The unsupported sol structure may be formed and applied to a product by laying or placing the unsupported sol layer on the product, heating the sol layer when in contact with the product, applying pressure to promote adhesion of the sol layer onto the product, or any combination thereof.

The inclusion of a protein in the sol of the present invention may serve to enhance one or more properties of the comparable sol formed without a protein. In particular, the inclusion of a protein may improve the water impermeability, water resistance, oil impermeability, oil resistance, gas impermeability, gas resistance, general fluid resistance, or general fluid impermeability of the sol. An improvement in resistance or impermeability is determined as an increase in the time required for a fixed volume of a given fluid to pass through a layer of the sol barrier of a given thickness under comparable temperature and pressure conditions. It has also been observed that a sol including a protein may possess different properties to a comparable sol not including the same protein. For example, it has been found that a sol including a protein may form a fluid resistant or fluid impermeable coating with a greater thermal tolerance than the comparable protein formulation alone. In an example a sol may form a water impermeable, but not oil impermeable barrier that remains water impermeable at 150° C. Corn protein in the absence of the other components of a sol described herein may form an oil impermeable, but not water impermeable, barrier that remains oil impermeable, at 150° C. A barrier formed from the sol including the corn protein may form a barrier that is both water and oil impermeable and retains the both water and oil impermeability at 150° C. These examples are merely used to illustrate the potential advantages of the protein-containing sols described herein and are not intended to suggest that any particular protein or sol exhibits any particular property when used in the formation of a barrier. Without being bound by theory, it is believed that the sol network and the protein network form a single interlinked or interlinking network structure that results in a chemically district arrangement when compared to a sol network when formed alone or a protein network when formed alone. For example, both sols and proteins (such as prolamin proteins) are known to form network structures and the inventor of the present invention has appreciated that these networks may be both compatible and complimentary. The difference in properties between a sol comprising a solvent, an alkoxide and a catalyst, and a sol comprising the same solvent, alkoxide, catalyst an additionally a protein allows the use of a single layer, or multiple layers, of sols to form fluid resistant or fluid impermeable barriers or coatings that would otherwise be unachievable by one sol alone. In one example, a sol which forms a water impermeable barrier but not an oil impermeable barrier may be applied to a product as a first layer. Once the first layer is formed, a second sol layer which forms an oil impermeable barrier may be applied on top of the first layer. The resulting two layers thus form a barrier which is both water and oil impermeable. Moreover, the use of multiple complimentary sol layers in this manner has also been found to enhance the properties of the barrier when compared to either of the single sol species of similar thickness. For example, a first sol may form a coating which cracks when shaped but that retains its barrier cohesion when shaped in the presence of a second sol layer comprising a protein.

Coatings formed using the sols described herein may be applied to a composite product and/or a free-standing object formed from a sol as described herein. In this manner, a sol coating may be used to impart one or more desirable characteristics upon a composite material and/or free-standing object. When a sol coating is applied to a free-standing object formed from a sol as described herein, the sol used to form the sol coating may be the same, or different, as the sol used to form the free-standing object. Where the sol used to form the coating is different from the sol used to form the free-standing object, the sol coating may be used to impart additional properties such as water impermeability, water resistance, oil impermeability, oil resistance, gas impermeability, gas resistance, general fluid resistance, general fluid impermeability, thermal tolerance, impact tolerance, or other desirable properties to the free-standing object and/or may serve to enhance the existing properties of the free-standing object. In one example, the free-standing object may be formed from a first sol. The free-standing object may then be coloured using a pigment prior to application of a second sol to form a sol coating. In such examples where the first sol and the second sol are the same, the second sol may immobilise the pigment applied to the free-stranding object. In examples where the first sol and second sol are different, the second sol may immobilise the pigment applied to the free-standing object while also enhancing the water impermeability, water resistance, oil impermeability, oil resistance, gas impermeability, gas resistance, general fluid resistance, general fluid impermeability, thermal tolerance, impact tolerance of the free-standing object. In some particular examples, sols may be used to coat a free-standing sol product wherein the free-standing sol product is formed from a sol comprising wood chips, natural fibres, waste fibres, sand, cellulose, or other functional additives. Sols and their components, such as alkoxides, proteins, and or functional additives, may be selected to impart the desired characteristics at the discretion of the person skilled in the art.

The sols of the present invention may also be used as an adhesive. As described previously, products and/or materials coated with sols may be contacted with one or more coated or uncoated products and materials to allow them to adhere together. For the avoidance of doubt, the sol may be applied to the surface of a product, free-standing sol object, composite material, or the like, in the form of a coating, one of more drops or droplet, a spray, blobs, lines, or any other suitable means of application to act as an adhesive. In an example, the sol may be placed upon a product and then the product placed against another product to form a bonded product. The sol may form a bonded product by allowing the sol to dry, or by actively drying the sol by means of an oven or other suitable drying means. The sol as used in this manner may be used to form furniture from furniture components, to seal joins in packaging material or food and drink containers, or bind any other suitable products. The sol may be used as an adhesive to bind layers of two or more other materials to form a composite layered structure. In some examples, a sol or sol layer that has previously been applied to a product may be used as an adhesive by heating the previously applied sol or sol layer prior to using the sol or sol layer as an adhesive.

Products formed using the sols described herein may be treated using one or more processes during the formation, or after the formation of the product. In one example, the product may be washed. In another example, the product may be heated. Where the product including or formed using the sol is heated, the product and/or sol may be heated to a temperature of about 30° C., about 35° C., about 40° C., about 45° C., about 50° C., about 55° C., about 60° C., about 65° C., about 70° C., about 75° C., about 80° C., about 85° C., about 90° C., about 95° C., about 100° C., about 105° C., about 110° C., about 115° C., about 120° C., about 130° C., about 140° C., about 150° C., about 160° C., about 170° C., about 180° C., about 190° C., about 200° C., about 210° C., about 220° C., or more. Where a product and/or sol is heated, the maximum temperature to which the product and/or sol is heated may depend upon the thermal characteristics and behaviour of the sol and/or other material from which the product is formed. In yet another example, the product may be cut, eroded, sanded, smoothed, etched, or subjected to any other suitable process.

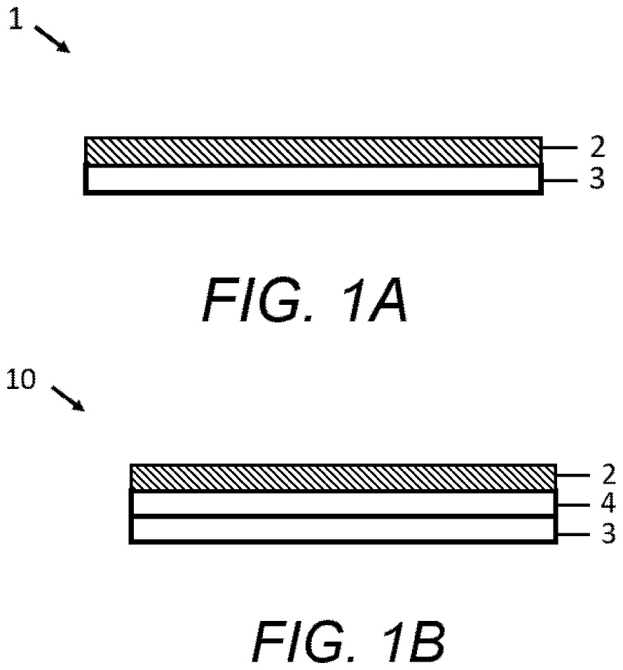

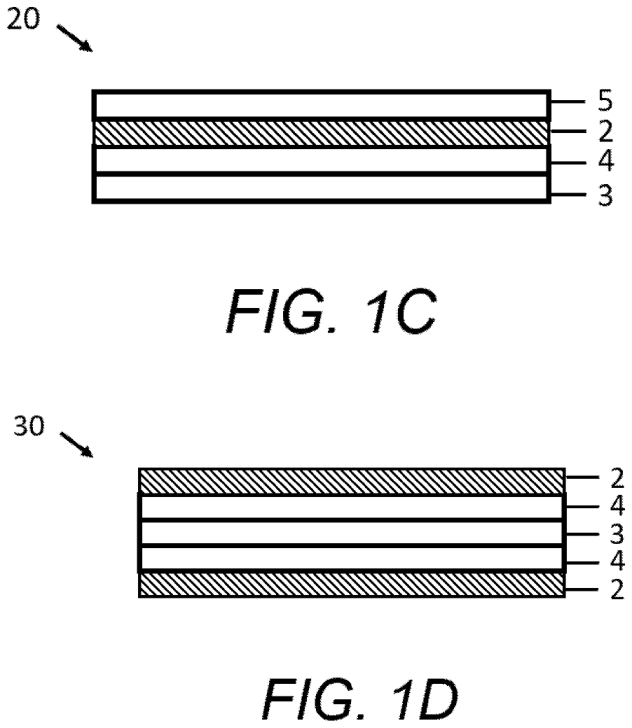

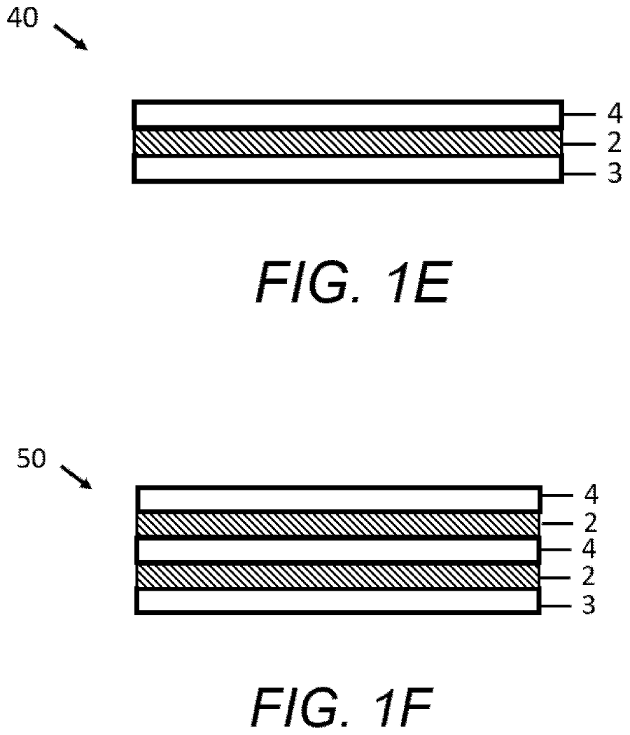

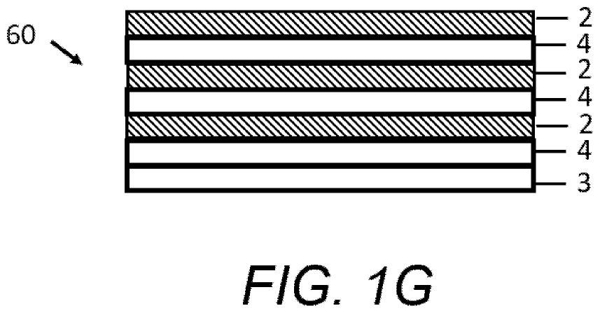

FIG. 1A shows an example of a coated product 1 formed from a sol layer 2 formed from a sol comprising an alkoxide, a solvent, a catalyst and a protein. The sol layer 2 is formed on the surface of the product 3. FIG. 1B shows an example of a coated product 10 including a sol layer comprising an alkoxide, a solvent, a catalyst and a protein 2. Sol layer 2 is formed on top of another layer of sol 4 which is positioned between sol layer 2 and the product 3. In the example of FIG. 1B, sol layer 2 may be water impermeable whereas sol layer 4 may be oil impermeable. Alternatively, sol layer 4 may be gas impermeable and water impermeable whereas sol layer 2 may be gas and oil impermeable. Any combination of sols with different or similar functionalities may be layered in this manner. The coated product 10 will prevent the ingress of the desired fluids into the product from one side of the product. However, the product 3 may still be exposed to any fluid approaching from the side of the product 3 which is uncoated. FIG. 1C shows an example of yet further layering that may be applied to the coated product shown in FIG. 1B. Coated product 20 includes an additional layer 5 which may be formed from a sol or from other material. Layer 5 may, for example, be a label or layer of printed material used to identify the coated product 20. Layer 5 may additionally, or alternatively, be a functional layer chosen to impart one or more properties to the product 3 that may or may not be provided by sol layers 2 or 4. FIG. 1D shows an example of a coated product 30 where the product 3 has been coated on both sides with a first sol layer 4 and a second sol layer 2 comprising a protein. In this example, the product 3 is provided impermeability from fluid from either direction. Such a barrier arrangement may prove advantageous for products that require resistance to fluid ingress or egress such as food and drink containers, pharmaceutical packaging, cosmetic packaging, and the like. For the avoidance of doubt, the configuration and sequence of layers exemplified in FIGS. 1A to 1D are merely illustrative and should not be considered limiting. FIG. 1E shows an alternative example of a coated product 40 where the sol layer 2 including an alkoxide, a solvent, a catalyst and a protein is positioned on the surface of the product 3 with a further sol layer 4 applied onto sol layer 2. As will be appreciated from FIG. 1E and FIGS. 1A to 1D, the order of layers 2, 4, and 5 in the relevant figures could be arranged in any desired order, sequence, or configuration at the discretion of the skilled person. Any number of sol layers may be applied in any order to a product as depending upon the properties or characteristics of the coating to be imparted to the product. FIG. 1F shows a coated product 50 with multiple layers of protein containing sol 2 and multiple layers of sol without protein 4 layered upon a product 3. The coated product 3 has a layer of protein containing sol 4 against the surface of the product 3, followed by a layer of sol without protein 4, before the layering pattern repeats with a layer of sol with protein 2 followed by a layer of sol without protein 4. FIG. 1G shows a further example of a coated product 60 with multiple layers of sol. The coated product 60 include six alternating layers of sol without protein 4 and sols with protein 2 with a layer of sol without protein 4 adjacent to the product 3. For the avoidance of doubt, any number of layers may be formed upon a product 3 and additional layers such as layer 5 of FIG. 10 may be included, interspersed, or provided on top of, beneath, in between any sequence or frequency of sol layers, as desired.

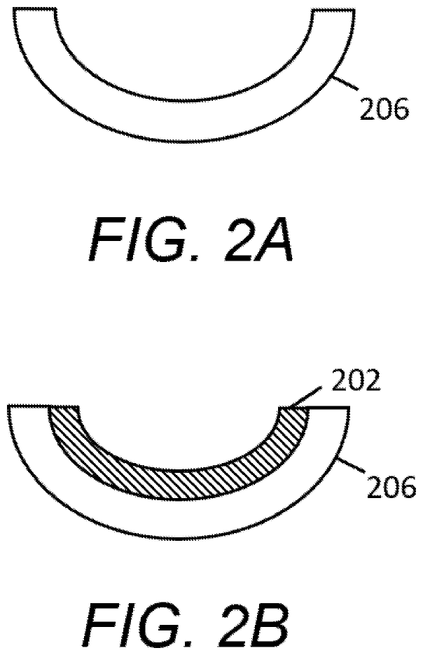

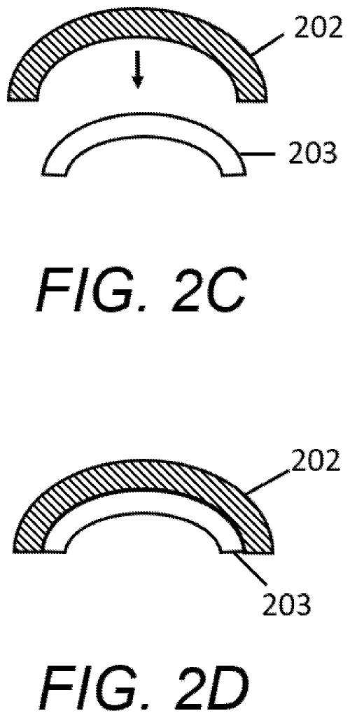

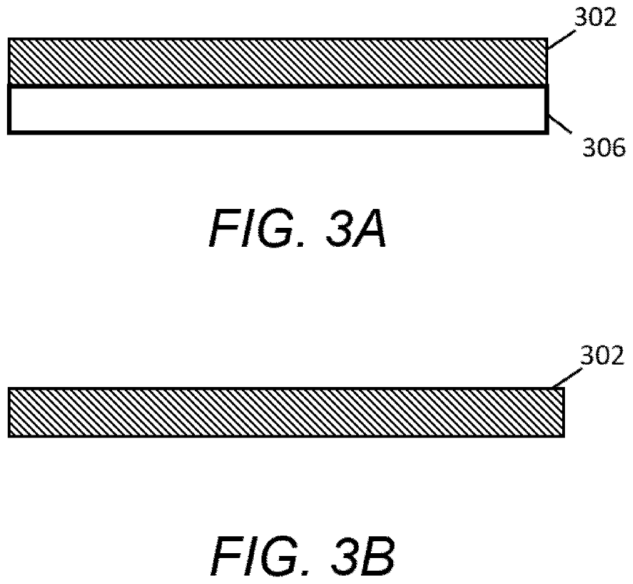

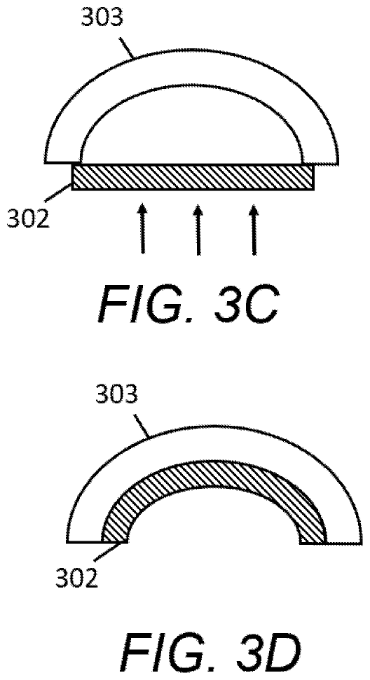

FIG. 2A shows a shaped mould 206 which may be used to shape a sol layer prior to its application to a product. When a sol 202 is applied to the mould 206 as shown in FIG. 2B, it may form a shape as dictated by the shape, contours, and configuration of the mould 206. The sol may be allowed to dry, or partially dry, in the mould. Additionally, or alternatively, the sol may be heated in the mould. One the sol 202 has formed the desired shape, the sol 202 may be removed from the mould 206 to form a free-standing and unsupported sol layer as shown in FIG. 2C. The free-standing and unsupported sol layer 202 may be applied to a product 203 as further shown in FIG. 2C. Preferably, the shape of the mould 206 will be selected such that the sol layer 202 is suitably shaped to fit onto the desired portion of the product 203. Once the sol layer 202 has contacted the product 203 as shown in FIG. 3D, the sol layer may be subjected to one or more further processes to promote adhesion of the sol layer to the product. Such processes may include applying pressure to the sol layer 202, heating the sol layer 202 and/or the product 203, or any other suitable means of adhesion promotion.

FIGS. 3A to 3D show an alternative means of forming a free-standing and unsupported sol layer and applying it to a product. In FIG. 3A, a sol layer 302 has been formed on the surface of object 306. The sol layer 302 once formed may thereafter be removed from the object 306 to form a free-standing and unsupported sol layer 302 as shown in FIG. 3B. Due to the substantially planar surface of object 306, the sol layer 302 is not shaped to match the surface topography of the product 303 to which it is to be applied. To shape the sol layer 302 into a more suitable form, the sol layer 302 may be subjected to a gas moulding technique wherein higher than ambient pressure air or gas is blow onto the surface of the sol layer as shown by the directional arrows in FIG. 3C. It may be advantageous to carry out the gas moulding process by also heating the sol layer 302 or by applying heated gas or air during the process. FIG. 3D shows an example of a resulting product formed following the gas moulding process of FIG. 3C with sol layer 302 conforming to the surface shape of the product 303.

Although FIGS. 2A to 2D and 3A to 3D show the application of a single sol layer to a product, such examples do not exclude the possibility of one or more further layers. For example, such techniques may be used to apply multiple layers to a product in succession. Additionally, or alternatively, the product to which the sols are applied may already include one or more coatings or barrier layers prior to the enactment of the processes demonstrated in FIGS. 2 and 3.

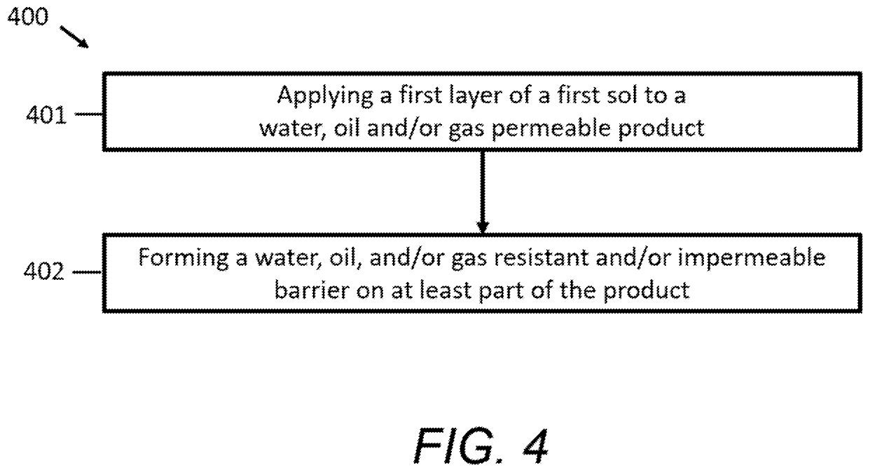

In general, a process for a process for forming a water, oil, and/or gas resistance and/or impermeable product may be carried out as shown in FIG. 4. The process 400 of FIG. 4 includes applying 401 a first layer of a first sol to a water, oil and/or gas permeable product, the first sol comprising a sol described substantially herein. The process 400 of FIG. 4 further includes forming 402 a water, oil, and/or gas resistant and/or impermeable barrier on at least part of the product. The process of FIG. 4 may include one or more additional process steps. In one example, the process may further include applying a second layer of a second sol to the product, wherein the second sol comprises a solvent, an alkoxide, and a catalyst. The formation of two different sol layers may synergistically form a layer with distinct properties not provided by either individual sol. As previously described herein, the use of multiple sols may also enhance the thermal tolerances of the coating or barrier layer thus formed. In an example with a first sol layer and a second sol layer, the first sol and the second sol may therefore be different. It may be advantageous for only one of the first sol and second sol to include a protein. In general, the first sol may be applied to the product prior to the application of the second sol to the product; or alternatively the second sol may be applied to the product prior to the application of the first sol to the product. In the event that one layer is more resistant and/or impermeable to a particular fluid than another layer, it may be advantageous to position the layer with the greater resistance or impermeability to the fluid posing the greatest risk to the product in a position where said fluid will encounter the layer prior to encountering the layer with lower inherent resistance or impermeability. The first sol and/or second sol may be applied to a product using any technique or combination of techniques disclosed here. For example, one or more layers may be applied to the product by spraying the sol onto the product, soaking the product in the sol, dipping the product in the sol, roller coating the sol onto the product, brushing the sol onto the product, wiping the sol onto the product, impregnating the product with the sol by padding, exhausting the sol on the product, flowing the sol onto the product, the use of slit coating techniques, the use of blade application techniques, or any combination thereof. Each layer may be applied by the same technique, or by different techniques, as desired. Applying the first layer of the first sol to the product may involve partially drying at least a portion of the first sol to form a deformable intermediate first sol layer free of the product and subsequently contacting the intermediate first sol layer and the product. Where a deformable, free-standing or unsupported intermediate sol layer is formed, the process may further include heating the sol layer and the product after contacting, pressing the product and the sol layer together after contacting, or any combination thereof. A deformable, free-standing or unsupported intermediate sol layer may be formed in a shaped mould, via gas moulding techniques, by mechanical manipulation, any other suitable technique, or any combination thereof.

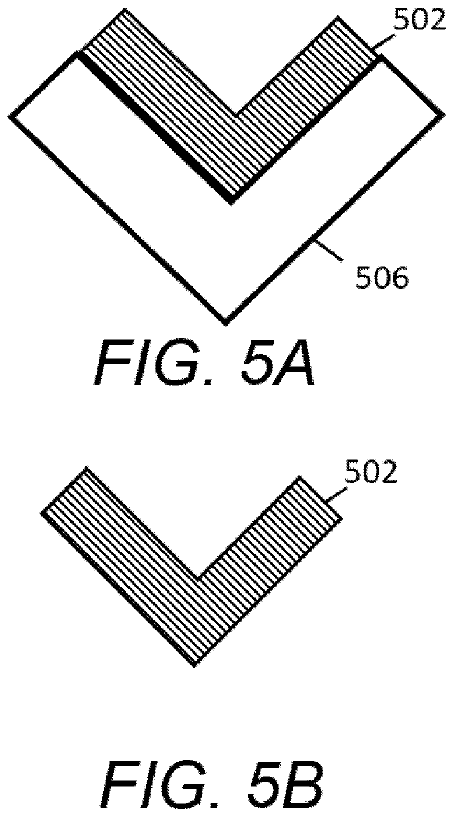

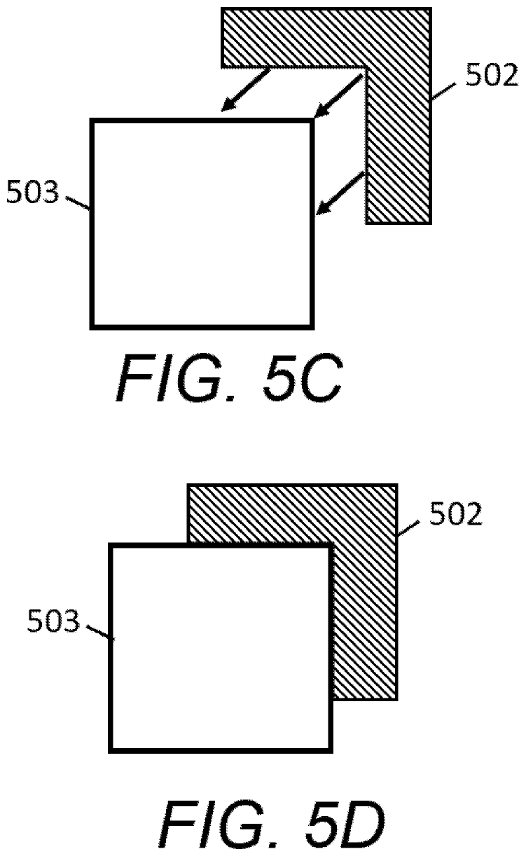

The free-standing and unsupported sol layers 202 and 302 of FIGS. 2 and 3 may be used without direct application to a product. In such examples, the free-standing and unsupported sols may themselves form a product. A free-standing structure or object may therefore comprise the sols as described substantially herein, or be derived from the sols as described substantially herein. It should be noted that the free-standing and unsupported layers 202 and 302 are merely examples and that such free-standing and unsupported structures are not limited to layers, as such. Examples of products that may be formed by the free-standing and unsupported sol structures may include liquid receptacles, liquid seals, gas seals, oil seals, packaging components, reinforcement materials, construction materials, product sub-components, furniture, room fixtures, automotive components, sports equipment, aircraft components, electronics, and the like. Free-standing and unsupported sol structures may include one or more functional additives to further enhance their suitability to form free-standing and unsupported structures. For example, the sol may include a synthetic or natural fibre additive. Addition of one or more fibrous additives to the sol before and/or during the formation of the free-standing and unsupported structure has been found to increase the impact resistance and compressive strength of a free-standing sol structure. Other functional additives such as biowaste, bioash, carbonaceous materials, and the like may also be used independently or in combination to modify the strength, density, rigidity, temperature tolerance, or any other suitable characteristic of the free-standing sol structure. FIG. 5A shows the formation of a free-standing sol structure 502 in a mould 506. The free-standing sol structure 502 formed in this manner may be in the form of a layer. Alternatively, the free-standing sol structure 502 formed in mould 506 may not conform to a ‘layer’ and may instead be a three-dimensional shape of conventional geometry or, alternatively, an irregular shape. The sol added to the mould 506 may include one or more functional additives, such as fibrous additives prior to its addition to mould 506 and/or one or more functional additives, such as fibrous additives, may be added to the sol structure 502 during the formation of the free-standing structure in the mould. The free-standing sol structure 502 may then be removed from the mould to stand freely as shown in FIG. 5B. The free-standing sol structure may then be used without being subjected to further processes or modifications. For example, the free-standing sol structure of FIG. 5B may be directly utilised as a product. In other examples, the free-standing sol structure may be subjected to one or more additional processes or modifications. For example, the free-standing sol structure may be subjected to a finishing process, a thermal treatment process, heating, milling, sanding, grinding, painting, washing, drying, any process with or without the presence of vacuum pressure, any other suitable process, or any combination thereof. The free-standing sol structure 502 may be applied to all or part of one or more other products 503 as shown in FIGS. 5C and 5D. The free-standing sol structure 502 may therefore be used as a component part in product 506.

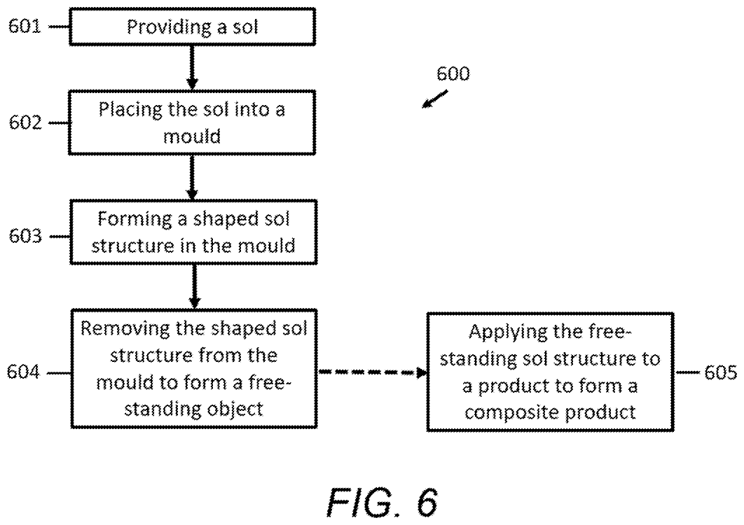

FIG. 6 shows a method 600 by which a free-standing object or sol structure may be formed. The method includes providing 601 a sol as described substantially herein and placing 602 the sol into a mould. The method then includes forming 603 a shaped sol structure in a mould, and removing 604 the shaped sol structure from the mould to form a free-standing object or sol structure. The method may also include adding one or more materials and/or functional additives to the sol prior to the providing 601 step, during the providing 601 step, between the providing step 601 and the placing step 602, during the placing 602 step, between the placing 602 step and the forming 603 step, or while forming 603 the sol structure in the mould. Materials that may be added in this manner may include, but are not limited to, lignin, nano-cellulose, micro-cellulose, calcium carbonate, clay, kaolin, gelatine, oleic acid, rosemary oil, black seed oil, wood chips, natural fibres, waste fibres, sand, cellulose, starch, sorbitol, plasticising agents, and the like, or any combination thereof. The method may also include applying 605 the free-standing sol structure to a product to form a composite product. The sol and/or free-standing object may also be subject to one or more additional processes during or after the method. Such additional processes may include heating the sol and/or free-standing object, drying the sol and/or free standing object, applying pressure to the sol and/or free standing object, washing the free standing object, post processing the free-standing object, or any other suitable process as determined by the intended use or function of the sol and/or free-standing object. In one example, the sol may be heated and/or dried once placed into the mould to aid in the formation of the free-standing object. The sol may also be separated from its solvent at any suitable part of the method. For example, the sol solvent may be evaporated, separated via suitably fine filtration, or any other solvent separation technique. The sol with a reduced solvent loading may then be used in the methods described herein, such as that shown in FIG. 6. For example, the sol with a reduced solvent loading may be used in the mould process to form a shape. In another example, the sol with reduced solvent loading may be used to form a coating on at least a portion of one or more products.

### EXAMPLES

The invention may be further understood in consideration of the following examples. All chemicals were used as received without further purification.

### Example 1 Comparative Example

10 g zein corn protein was mixed with 20 ml ethanol for a period of 30 minutes and allowed to rest.

### Example 2 Example

Zein corn protein (10 mg) was dispersed in a mixture of ethanol (15 ml) and aqueous HCl (0.1 M, 1.6 ml) to produce a solution with pH 2. To this stirred solution, silicon alkoxide precursor mixtures (5.2 ml) composed of 50% tetraethyloxysilane and 50% methyltriethoxysilane were added dropwise before stirring was continued for a further 1 hour then allowed to rest.

### Example 3 Example

Cationic Starch (CS; 5 mg) was dispersed in a mixture of ethanol (15 ml) and aqueous HCl (0.1 M, 1.6 ml) to produce a solution with pH 2. To this stirred solution, silicon alkoxide precursor mixtures (5.2 ml) composed of 50% tetraethyloxysilane and 50% methyltriethoxysilane were added dropwise before stirring was continued for a further 1 hour. 10 g zein corn protein was mixed with the entire volume of the formed sol for a period of 30 minutes and allowed to rest.

### Example 4 Formation of Coated Products

Approximately 2 to 3 ml of the samples formed in examples 1 to 3 were coated as a thin layer using drawdown techniques on A4 paper sheets made from virgin paper fibre. Each coated sheet was then tested for water impermeability using a COBB test apparatus “COBB SIZING TESTER CT series” as sold by TECHLAB SYSTEMS and the TAPPI T 441 Cobb Test method. Each sheet was tested for oil impermeability by placing droplets of ˜0.5 ml of oil on the surface of each paper sheet and observing whether the droplets were absorbed or partially absorbed by the sheet over the course of 3 days. The paper sheet coated with the sample prepared in example 1 was oil impermeable but exhibited water permeability after less than 1 hour. The paper sheets coated with the samples prepared in examples 2 and 3 demonstrated water and oil impermeability throughout the entire period of observation.

### Example 5 Formation of Coated Products

A sol was prepared as follows. Cationic Starch (CS; 5 mg) was dispersed in a mixture of ethanol (15 ml) and aqueous HCl (0.1 M, 1.6 ml) to produce a solution with pH 2. To this stirred solution, silicon alkoxide precursor mixtures (5.2 ml) composed of 50% tetraethyloxysilane and 50% methyltriethoxysilane were added dropwise before stirring was continued for a further 1 hour. This sol was then used to coat paper sheets and allowed to dry to form coated paper sheets. The samples formed in examples 1 to 3 were then coated as a thin layer using drawdown techniques on the previously coated paper sheets. Each coated sheet with two layers of sol was then tested for water and oil impermeability using the COBB testing and oil droplet methods described in example 4. All coated sheets demonstrated both oil and water impermeability throughout the entire period of observation.

### Example 6 Formation of Coated Products

Additional samples were prepared as outlined in examples 1 to 3 using each of 2.5 g zein corn protein, 5 g zein corn protein, and 7.5 g zein corn protein. The volume of sols used in the preparations described in examples 2 and 3 were also varied at 5 ml, 10 ml, 15 ml, 20 ml, and 25 ml to form a sample matrix at various concentrations of zein corn protein relative to different concentrations of sols. These samples were then applied to virgin paper sheets, commercially available water impermeable paper sheets, and pre-coated paper sheets as described in examples 4 and 5 and the oil and water impermeability of each coated paper sheet was assessed using the COBB testing and oil droplet methods described in example 4. Comparable results to those described in examples 4 and 5 were obtained.

### Example 7 Formation of Coated Products

Additional examples were prepared as outlined in examples 1 to 3 but with the addition of 5 ml of water to each sample prior to allowing each sample to rest. These samples were then applied to virgin paper sheets and pre-coated paper sheets as described in examples 4 and 5 and the oil and water impermeability was assessed using the COBB testing and oil droplet methods described in example 4. Comparable results to those described in examples 4 and 5 were obtained.

### Example 8 Formation of Unsupported Layers

The samples prepared in examples 1 to 3 and example 6 were added to petri dishes and allowed to dry overnight to form thin films. The films were removed intact from the petri dishes and the oil and water impermeability of each film was assessed. The samples including only zein corn protein demonstrated water permeability and oil impermeability. The samples including zein corn protein in addition to sols demonstrated both water and oil impermeability throughout the entire period of observation.

### Example 9 Formation of Unsupported Layers

The samples prepared in examples 1 to 3 and example 6 were applied to metal sheets and subsequently drawn down over the metal sheet to form a thin film. The films were allowed to air dry for a period of 30 seconds. The coatings formed on the metal sheets were peeled off of the metal based to form unsupported and free-standing sheets formed from the sols.

### Example 10 Formation of Coated Products

The unsupported sol layers formed in example 9 were applied onto a sheet of virgin paper prior to heat pressing the sol sheet against the paper sheet for a period of 5 seconds at ˜150° C. The experiment was repeated at a lower temperature of 60° C. with an extended press time of 30 seconds. The coated paper sheets thus formed were tested for water and oil impermeability using the COBB testing and oil droplet methods described in example 4. The samples including only zein corn protein demonstrated water permeability and oil impermeability. The samples including zein corn protein in addition to sols demonstrated both water and oil impermeability throughout the entire period of observation.

### Example 11 Formation of Coated Products

The samples prepared in examples 1 to 3 were drawn down over air-laid pulp and dry fibre samples to form a thin film over each sample. Each pulp sample was then dried in an oven for 10 minutes at 60° C. before samples were removed and tested for oil and water impermeability using the COBB testing and oil droplet methods described in example 4. The samples including only zein corn protein demonstrated water permeability and oil impermeability. The samples including zein corn protein in addition to sols demonstrated both water and oil impermeability throughout the entire period of observation.

### Example 12 Coated Pots

Cationic Starch (CS; 5 mg) was dispersed in a mixture of ethanol (15 ml) and aqueous HCl (0.1 M, 1.6 ml) to produce a solution with pH 2. To this stirred solution, silicon alkoxide precursor mixtures (5.2 ml) composed of 50% tetraethyloxysilane and 50% methyltriethoxysilane were added dropwise before stirring was continued for a further 1 hour. The sol thus formed was diluted to 5% by volume and used to coat the exterior of a paper pot. The samples prepared in examples 2 and 3 were brushed onto the exterior of the coated paper pot. The resulting pot was placed in an oven and dried for 10 minutes at 60° C. Hot water was placed in the interior of the pot and the progression of water through the pot was observed. The volume of water forming beadlets due to vapour passage through the coating layer was reduced by approximately 70% when compared with a coated pot without the application of the samples of examples 2 or 3.

### Example 13 Coated Fibre Product

The coating sequence applied to the pots prepared in example 12 was applied to a fibre product. Droplets of water containing surfactant soap was placed on to the coated fibre product. No water was observed to penetrate through the coated fibre product.

### Example 14 Gas Moulding of Sol Mixtures

The samples prepared in examples 1 to 3 were left to dry at room temperature until they became a solid disc with approximately 1 cm thickness. Each sample was placed on a metal sheet and placed in the oven for 10 minutes at 90-110° C. The samples began to melt at approximately 90° C. Hot air was introduced into the melted samples which caused the samples to inflate and form domed bubble or shell shapes. The temperature was then increased sequentially to 100° C. and 110° C. to settle the shape before removal of the shape from the oven. Once removed from the oven the solidified samples retained their inflated shape.

### Example 15 Formation of Coated Products

5 g of zein corn protein was dissolved in 100 ml of a sol formed from ethanol, 50% tetraethyloxysilane and 50% methyltriethoxysilane, and hydrochloric acid. The resulting sol was then mixed with water in the ratio of 50:50 and which formed a visibly cloudy solution. The cloudy solution was then sprayed on to paper, cardboard, air-laid pulp, and dry fibre samples to form a layer on each product. The resulting products were tested for oil and water impermeability and were found to be both water and oil impermeable.

### Example 16 Formation of Coated Products

5 g of zein corn protein was dissolved in 100 ml of a sol formed from ethanol, 50% tetraethyloxysilane and 50% methyltriethoxysilane, cationic starch, and hydrochloric acid. The resulting sol was then mixed with water in the ratio of 50:50 and which formed a visibly cloudy solution. The cloudy solution was then sprayed on to paper, cardboard, air-laid pulp, and dry fibre samples to form a layer on each product. This resulting products were tested for oil and water permeability and were found to be both water and oil impermeable.

### Example 17 Adhesion of Double Fibre Layer

Two fibre sheets were coated as described in example 4. The sheets were then placed together with the coated sides touching and were heat pressed at 60° C. for 30 seconds. The two paper sheets adhered together to form a double layered fibre sheet. Droplets of water and oil were placed on one side of the double layer of fibre and allowed to rest for a period of 4 hours. No water or oil was observed to penetrate through to opposite side of the double layered paper sheet. The experiment was repeated with fibre sheets coated as described in example 5 and comparable results were obtained.

### Example 18

Fibre sheets were coated with (i) zein corn protein in ethanol; (ii) a sol formed from ethanol, 50% tetraethyloxysilane and 50% methyltriethoxysilane, cationic starch, and hydrochloric acid; or (iii) a sol formed from ethanol, 50% tetraethyloxysilane and 50% methyltriethoxysilane, cationic starch, hydrochloric acid, and zein corn protein. Each coated sheet was heated to 150° C. for a period of 30 minutes before being tested for water and oil impermeability using the COBB testing and oil droplet methods described in example 4. The sheet coated in zein corn protein showed oil impermeability and water permeability. The sheet coated in the sol without any corn protein demonstrated water impermeability and oil permeability. The sheet coated in the sol containing protein showed both water and oil impermeability.

### Example 19

Sols were formed as follows:
(i) Zein corn protein (10 mg) was dispersed in a mixture of ethanol (15 ml) and aqueous HCl (0.1 M, 1.7 ml). To this stirred solution, 5.2 ml of tetraethyloxysilane (100%) was added dropwise before stirring was continued for a further 1 hour then allowed to rest.
(ii) Cationic Starch (CS; 5 mg) was dispersed in a mixture of ethanol (15 ml) and aqueous HCl (0.1 M, 1.7 ml). To this stirred solution 5.2 ml of tetraethyloxysilane (100%) was added dropwise before stirring was continued for a further 1 hour. 10 g zein corn protein was mixed with the entire volume of the formed sol for a period of 30 minutes and allowed to rest.
   The experiments outlined in examples 4, 6, 7, 8, 9, 10, 11, and 14 were repeated using the sample formed in example 1 and sols (i) and (ii). Identical results were obtained using sols (i) and (ii) as were observed in original examples 4, 6, 7, 8, 9, 10, 11, and 14.

### Example 20

Multiple sols were prepared using one or more of the following alkoxides: tetraethylorthosilane, triethoxy(octyl)silane, tetrapropylorthosilicate, triethoxyphenylsilane methyltriethylsilane, zirconium(IV) butoxide, aluminum isopropoxide, and triethoxy-3(2-imidazolin-1-yl)propylsilane and either (i) no biopolymer; (ii) wheat flour; or (iii) cationic starch. To each sol thus formed, samples were prepared including one or more of the following additives: (a) zein protein; (b) lignin; (c) nano-cellulose; (d) micro-cellulose; (e) calcium carbonate; (f) gelatine; (g) oleic acid; (h) rosemary oil; and (i) black seed oil.

The sol samples prepared above were: (1) poured into moulds to form free-standing three-dimensional objects; (2) used to form thin planar sheets, and/or; (3) used to form thick planar sheets. Water and oil droplets were placed on the surface of each of the free-standing three-dimensional objects, thin planar sheets, and thick planar sheets formed in (1), (2), and (3) for a period of 15 minutes. After 15 minutes had elapsed, the droplets were removed and the surfaces assessed for permeability to water and/or oil. All samples tested showed no penetration of water or oil.

### Example 21

The multiple sols prepared during example 20 were mixed with (A) wood chips; (B) natural reinforced fibres and waste fibres; (C) sand; and (D) shredded cellulose to form sol composites. The sol composites were placed into a cylindrical mould and allowed to set to form a free-standing three dimensional object. Each object was subjected to hydrophobicity, oleophobicity, and strength testing before and after (I) submersion in hot water; (II) submersion in cold water; (Ill) prolonged exposure to >100° C. Tests (I) and (II) resulted in no deterioration in the hydrophobicity, oleophobicity, or strength of each sample. Test (III) demonstrated improvements in compressive strength and impact resistance.

### Example 22

The free-standing sol samples formed in (A) in example 21 were dried in an oven and then tested in comparison to an equivalent volume of commercially available wood chip board. The dried sol sample demonstrated increased strength, increased hydrophobicity and oleophobicity, and a reduction in density of approximately 50%.

### Example 23

The multiple sols prepared during example 20 were used to coat mushroom mycelium composites. The coated composites were tested for impact resistance, compressive strength, hydrophobicity and oleophobicity. The coated composites were found to be more impact resistant and stronger than the uncoated base product. The coated product also exhibited hydrophobicity and oleophobicity whereas the uncoated product demonstrated permeability to water and oil.

### Example 24

The experiment of example 23 was repeated on mushroom mycelium structures that had been dyed with yellow, red, blue, and green pigmentation. Decolouration resistance tests were performed on the coated and uncoated pigmented mycelium structures. Dye and pigment loss were substantially prevented in the coated samples whereas depigmentation and dye loss were observed in the uncoated mycelium.

The experiment of example 23 was repeated again using uncoloured mushroom mycelium structures and sols with added pigment. In addition to increased strength, hydrophobicity, and olepphobicity, the coated mushroom mycelium structures were observed to gain a light colouring of pigment when compared to the uncoated mushroom mycelium structures.

The pigment containing sols were then used to coat dyed mushroom mycelium structures. In addition to the benefits already described, an enhanced colouration was observed when compared to the use of pigmented sols on undyed mushroom mycelium or colourless sols on dyed mushroom mycelium.

### Example 25 Adhesion of Wooden Sheets

Droplets of sols including zein protein were applied to 5 cm thick wooden sheets and a second 5 cm wooden sheet was pressed on top of each sample. The combined wooden sheets were dried in an oven at 80° C. for 3 hours before being removed from the oven and allowed to cool. Once cooled, attempts were made to prise the wooden sheets apart. The wooden sheets remained bonded and application of increased force demonstrated failure of the individual wooden sheets prior to failure of the sol adhesive bond in some examples.

### Example 26 Additional Proteins

The sols formed in Examples 1 to 3 and 6 were formed and additional sols were prepared using the same method with each of the following proteins individually in place of the equivalent mass of corn protein: (i) pea; (ii) hemp; (iii) rice; (iv) egg; (v) whey; (vi) champignon mushroom; (vii) cordyceps mushroom; and (viii) maitake mushroom. The sols thus formed were applied to paper sheets and allowed to dry. Each paper sheet demonstrated improvements in the water and/or oil resistance characteristics of the sheet.

### Example 27

The sol preparations of Example 26 were repeated and were used to coat a wood-fibre utensil. An uncoated control utensil, and each of the coated utensils were then submerged into water heated to a temperature in excess of 80° C. for a period of 10 minutes. The uncoated utensil demonstrated rapid saturation with water and demonstrated shape deformation within the initial 5-10 seconds of submersion. The utensils coated with sols containing proteins demonstrated reduced or limited deformation. Utensils with a greater loading of protein demonstrated the least deformation. Utensils coated with sols containing proteins from experiments (i) to (viii) of Example 26 demonstrated a maximum deformation of approximately 30% to 50% less than the uncoated control utensil. Utensils coated with sols containing zein corn protein demonstrated the least deformation with the sols with the greatest loading of zein corn protein exhibiting no deformation of the utensil throughout the experiment.

### Example 28

Multiple sols were formed including the following proteins (i) pea; (ii) hemp; (iii) rice; (iv) egg; (v) whey; (vi) champignon mushroom; (vii) cordyceps mushroom; (viii) maitake mushroom; and (ix) zein corn protein. The sols were used to form free-standing three-dimensional shapes and the shapes formed were tested for deformation resistance and strength. Each of the sols successfully formed a three-dimensional shape. The shapes formed from zein corn protein demonstrated the greatest strength and deformation resistance amongst the three-dimensional shapes. The stability and deformation resistance of the shapes was also enhanced.

1. A sol comprising a solvent, an alkoxide, a catalyst, and a protein, wherein the protein is a plant-derived protein, an animal-derived protein, a fungus-derived protein, or any combination thereof.

2. A sol according to claim 1, wherein the alkoxide is selected from silicon alkoxides, metal alkoxides, phosphorus alkoxides, organically modified alkoxides, and any combination thereof.

3. A sol according to claim 1, wherein the alkoxide is selected from n-propyltriethoxysilane, tetrapropyl orthosilicate, titanium(IV) tert-butoxide, titanium(IV) isopropoxide, triethyloxysilane, methyltriethyloxysilane, triethoxy(octyl)silane, phenyl-triethoxysilane, titanium(IV) ethoxide, triethoxy-silylcyclopentane, (3-glycidyloxypropyl) trimethoxysilane, cyclopentyltriethoxysilane, 3-amino-propyltriethoxysilane, triethoxy-3-(2-imidazolin-1-yl)propylsilane, and any combination thereof.

4. A sol according to claim 1, wherein the catalyst is at least one of an acid and/or a base optionally, wherein the catalyst is selected from hydrochloric acid, citric acid, nitric acid, acetic acid, sodium hydroxide, potassium hydroxide, ammonia, and any combination thereof.

5. (canceled)

6. A sol according to claim 1, wherein the solvent comprises water, one or more alcohols, and/or any combination thereof, optionally wherein the solvent comprises water, methanol, ethanol, isopropanol, butanol, ethylene glycol or any combination thereof.

7. A sol according to claim 1, wherein the protein comprises a plant-derived protein, optionally wherein the plant-derived protein comprises a prolamine protein.

8. A sol according to claim 7, wherein the protein comprises vegetable protein, nut protein, seed protein, legume protein, bean protein, pulse protein, grass protein, or any combination thereof optionally, wherein the protein comprises corn protein, pea protein, soy protein, oat protein, chickpea protein, wheat protein, barley protein, rye protein, sorghum protein, or any combination thereof, optionally wherein the protein comprises corn protein, optionally wherein the corn protein is zein protein.

9. (canceled)

10. A sol according to claim 1, wherein the protein comprises an animal-derived protein, optionally wherein the protein is a dairy protein, egg protein, poultry protein, livestock protein, or any combination thereof, optionally wherein the protein comprises whey protein.

11. A sol according to claim 1, wherein the protein comprises a fungus-derived protein, optionally wherein the protein is a chytridiomycota protein, a zygomycota protein, a glomeromycota protein, a ascomycota protein, a basidiomycota protein, or any combination thereof.

12. A sol according to claim 1, wherein the sol consists essentially of a solvent, an alkoxide, a catalyst, and a protein.

13. A process for forming a water, oil, and/or gas resistant and/or impermeable product, the process comprising:
applying a first layer of a first sol to a product, the first sol comprising a sol as claimed in claim 1;
forming a water, oil, and/or gas resistant and/or impermeable barrier on at least part of the product.

14. A process as claimed in claim 13, the process further comprising applying a second layer of a second sol to the product, wherein the second sol comprises a solvent, an alkoxide, and a catalyst, optionally, wherein the first sol and the second sol are different.

15. (canceled)

16. A process as claimed in claim 14, wherein only one of the first sol and second sol comprise a protein.

17. A process as claimed in claim 14, the process comprising applying a second layer of a second sol to the product, wherein:
(i) the first sol is applied to the product prior to the application of the second sol to the product; or
(ii) the second sol is applied to the product prior to the application of the first sol to the product.

18. A process as claimed in claim 14, wherein the first sol and/or second sol are applied to the product by
spraying the sol onto the product,
soaking the product in the sol,
dipping the product in the sol,
roller coating the sol onto the product,
brushing the sol onto the product,
wiping the sol onto the product,
impregnating the product with the sol by padding,
exhausting the sol on the product,
flowing the sol onto the product,
the use of slit coating techniques, the use of blade application techniques, or any combination thereof

19. A process as claimed in claim 14, wherein applying the first layer of the first sol to the product comprises:
partially drying at least a portion of the first sol to form an intermediate first sol layer; and
contacting the intermediate first sol layer and the product;
optionally wherein the process further comprises heating the sol layer and the product after contacting, pressing the product and the sol layer together after contacting, or any combination thereof.

20. A process as claimed in claim 19, wherein the intermediate first sol layer is formed in a shaped mould or, the intermediate first sol layer is shaped by gas moulding.

21. (canceled)

22. A process as claimed in claim 14, wherein the intermediate first sol layer is resiliently deformable, elastically deformable, or deformable.

23. A product comprising a coating formed from a sol as claimed in claim 1.

24. A free-standing object derived from a sol, the sol comprising a solvent, an alkoxide, a catalyst, and a protein, wherein the protein is a plant-derived protein, an animal-derived protein, a fungus-derived protein, or any combination thereof.

25. A free-standing object according to claim 24, wherein the free-standing object is substantially solid.

26. A free-standing object according to claim 24, wherein the alkoxide is selected from silicon alkoxides, metal alkoxides, phosphorus alkoxides, organically modified alkoxides, and any combination thereof, optionally wherein the alkoxide is selected from n-propyltriethoxysilane, tetrapropyl orthosilicate, titanium(IV) tert-butoxide, titanium(IV) isopropoxide, triethyloxysilane, methyltriethyloxysilane, triethoxy(octyl)silane, phenyl-triethoxysilane, titanium(IV) ethoxide, triethoxy-silylcyclopentane, (3-glycidyloxypropyl) trimethoxysilane, cyclopentyltriethoxysilane, 3-amino-propyltriethoxysilane, triethoxy-3-(2-imidazolin-1-yl)propylsilane, and any combination thereof.

27. A free-standing object according to claim 24, wherein the catalyst is at least one of an acid and/or a base, optionally wherein the catalyst is selected from hydrochloric acid, citric acid, nitric acid, acetic acid, sodium hydroxide, potassium hydroxide, ammonia, and any combination thereof.

28. A free-standing object according to claim 24, wherein the solvent comprises water, one or more alcohols, and/or any combination thereof, optionally wherein the solvent comprises water, methanol, ethanol, isopropanol, butanol, ethylene glycol or any combination thereof.

29. A free-standing object according to claim 24, wherein the protein comprises a plant-derived protein, optionally wherein the plant-derived protein comprises a prolamine protein.

30. A free-standing object according to claim 32, wherein the protein comprises vegetable protein, nut protein, seed protein, legume protein, bean protein, pulse protein, grass protein, or any combination thereof, optionally wherein the protein comprises corn protein, pea protein, soy protein, oat protein, chickpea protein, wheat protein, barley protein, rye protein, sorghum protein, or any combination thereof, optionally wherein the protein comprises corn protein, optionally wherein the corn protein is zein protein.

31. A free-standing object according to claim 24, wherein the protein comprises an animal-derived protein, optionally wherein the protein is a dairy protein, egg protein, poultry protein, livestock protein, or any combination thereof, optionally wherein the protein comprises whey protein.

32. A free-standing object according to claim 24, wherein the protein comprises a fungus-derived protein, optionally wherein the protein is a chytridiomycota protein, a zygomycota protein, a glomeromycota protein, a ascomycota protein, a basidiomycota protein, or any combination thereof.

33. A free-standing object according to claim 24, wherein the free-standing object, the sol, or any combination thereof comprises one or more functional additives.

34. A free-standing object according to claim 33, wherein the one or more functional additives comprises fibres, optionally wherein the one of more functional additives are dispersed throughout the free-standing object.

35. A method of forming a free-standing object according to claim 24, the method comprising:
providing sol comprising a solvent, an alkoxide, a catalyst, and a protein, wherein the protein is a plant-derived protein, an animal-derived protein, a fungus-derived protein, or any combination thereof;
placing the sol into a mould;
forming a shaped sol structure in the mould;
removing the shaped sol structure from the mould to form a free-standing object.

36. A method according to claim 35, the method further comprising:
i) adding one or more functional additives to the sol prior to introduction to the mould, after the placing the sol into the mould, or during the forming the shaped sol structure in the mould; and/or,
(ii) heating the sol, drying the sol, applying pressure to the sol, or any combination thereof.

37. (canceled)

38. A product comprising a free-standing object according to claim 24.

39. A product according to claim 38, wherein
(i) the product consists essentially of the free-standing object; or,
(ii) the product further comprises one or more additional intermediate products or components, work in progress products or components, and/or semi-finished products or components.

40. (canceled)

41. A coating comprising a pigment and a sol, the sol comprising a solvent, an alkoxide, a catalyst, and a protein, wherein the protein is a plant-derived protein, an animal-derived protein, a fungus-derived protein, or any combination thereof.

42. A coating according to claim 41, wherein
(i) the sol forms a sol layer and the pigment is dispersed throughout the sol layer; or,
(ii) the sol forms a layer and the sol layer is in contact with the pigment.

43. (canceled)

44. A coating according to claim 41, wherein the coating coats a product formed at least in part from one or more plant, animal, or fungus derived materials, optionally wherein the coating coats a product formed at least in part from fungus derived materials.

45. A coating according to claim 41, wherein the pigment is immobilised, or substantially immobilised by the sol.
